(19) United States
(12) Patent Application Publication
(10) Pub. No.: US 2017/0220486 A1
(43) Pub. Date: Aug. 3, 2017

(54) DEVICE, METHOD OF CONTROLLING A CACHE MEMORY, AND STORAGE MEDIUM

(71) Applicant: FUJITSU LIMITED, Kawasaki-shi (JP)

(72) Inventor: Ken Iizawa, Yokohama (JP)

(73) Assignee: FUJITSU LIMITED, Kawasaki-shi (JP)

(21) Appl. No.: 15/397,149

(22) Filed: Jan. 3, 2017

(30) Foreign Application Priority Data
Feb. 1, 2016 (JP) 2016-017565

(51) Int. Cl. G06F 12/128; G06F 3/06

(52) U.S. Cl. CPC G06F 12/128; G06F 3/0689; G06F 3/0619; G06F 3/0665; G06F 2212/69

(57) ABSTRACT

A device includes a processor that calculates, based on a position of a first region of a storage and a current position of a head in the storage, a first time for reading the first region associated with a first block that is among blocks, which are associated with regions obtained by dividing the storage region of the storage and to be accessed by the head and temporarily store data stored in the regions, and that is determined as a candidate to be deleted based on a method, calculates, based on a position of a second region and the current position of the head, a second time for reading the second region associated with a second block that is not determined as the candidate to be deleted based on the method, and deletes the second block when the processor determines that the second time is shorter than the first time.

### CROSS-REFERENCE TO RELATED APPLICATION

This application is based upon and claims the benefit of priority of the prior Japanese Patent Application No. 2016-017565, filed on Feb. 1, 2016, the entire contents of which are incorporated herein by reference.

### FIELD

The embodiment discussed herein is related to a device, a method of controlling a cache memory, and a storage medium.

### BACKGROUND

A conventional technique is known to improve the performance of reading from a certain storage region using a cache memory able to be accessed at a higher speed than the certain storage region. In addition, a conventional technique is known to determine a block to be deleted among multiple blocks of a cache memory upon a cache miss.

As a related-art technique, a technique is known to define a sub-buffer, which is continuous from the start to end positions of the sub-buffer within a partial continuous region included in a buffer and determined to be used for reading from a magnetic disk, and to execute writing and reading in and from the sub-buffer in parallel. In addition, a technique is known to set divided memory regions of a cache memory and execute an operation of storing data in a certain memory region if it is determined that a request for the data is not a request to sequentially read the data. Furthermore, a technique is known to identify, upon a cache miss, a block to be deleted based on a time period for previous reading from a storage region.

Examples of related art are Japanese Laid-open Patent Publication No. 2006-185162, Japanese Laid-open Patent Publication No. 11-143643, and Jaeheon Jeong and another person, “Cost-Sensitive Cache Replacement Algorithms” and “Proceedings of the Ninth International Symposium on High-Performance Computer Architecture, 2003”.

### SUMMARY

According to an aspect of the invention, a device includes: a memory; and a processor coupled to the memory and configured to: calculate, based on a position of a first partial region within a storage region of a storage device and a current position of a head included in the storage device, a first time period for reading the first partial region associated with a first block that is among blocks, which are associated with partial regions obtained by dividing the storage region of the storage device and to be accessed by the head and temporarily store data stored in the partial regions, and that is determined as a candidate to be deleted based on a predetermined cache replacement method, calculate, based on a position of a second partial region within the storage region and the current position of the head, a second time period for reading the second partial region associated with a second block that is among the blocks and is not determined as the candidate to be deleted based on the predetermined cache replacement method, and delete the second block when the processor determines that the second time period is shorter than the first time period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of operations of an information processing device according to an embodiment;

FIG. 2 illustrates a detailed example of a storage system;

FIG. 3 illustrates an example of a hardware configuration of the information processing device;

FIG. 4 illustrates an example of a hardware configuration of a client device;

FIG. 5 illustrates an example of a functional configuration of the information processing device;

FIG. 6 illustrates an example of a write request;

FIG. 7 illustrates an example of stream data;

FIG. 8 illustrates access to an HDD included in a server upon writing and reading;

FIG. 9 is a flowchart of an example of a procedure for an entry replacement process;

FIG. 10 illustrates an example of the usage status of a RAM and the usage status of the HDD when a method for controlling a cache memory according to the embodiment is executed; and

FIG. 11 illustrates an example of the usage status of the RAM and the usage status of the HDD when an LRU method is executed.

### DESCRIPTION OF EMBODIMENT

According to the conventional techniques, the performance of reading using a cache memory from a storage region accessed by a head is reduced in some cases. For example, since the position of the head relative to the storage region is changed over time, a time period for reading data from the storage region varies depending on the position of the head. Thus, if a block that is to be deleted among multiple blocks is determined based on time periods for reading executed in the past, a block used to previously read data in a short time period is determined as the block to be deleted. There is, however, a possibility that a time period for reading executed next may be long. If the time period for the reading executed next is long, the performance of the reading using the cache memory from the storage region is reduced.

According to one aspect, an object of the present disclosure is to improve the performance of reading using a cache memory from a storage region accessed by a head.

An embodiment of an information processing device disclosed herein, a method, disclosed herein, for controlling a cache memory, and a program, disclosed herein, for controlling a cache memory is described in detail with reference to the accompanying drawings.

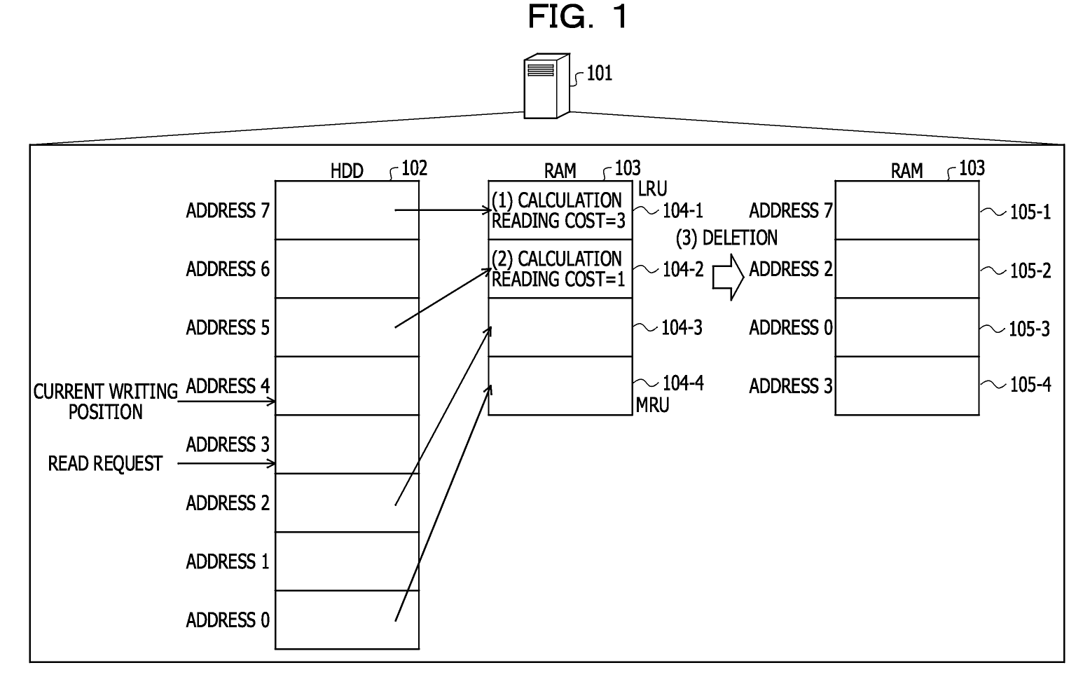

FIG. 1 illustrates an example of operations of an information processing device 101 according to the embodiment. The information processing device 101 is a computer that controls a cache memory. The information processing device 101 is a server, for example. The cache memory is a memory device with higher access performance than a storage device for storing data to be acquired and updated by a processing device such as a central processing unit (CPU). The cache memory temporarily stores data stored in the storage device. The difference between the performance of the storage device and the performance of the processing device is reduced by access to data by the processing device using the cache memory.

The cache memory is installed between the CPU and a random access memory (RAM) and stores a portion of data stored in the RAM, but is not limited to this. For example, the RAM may be treated as the cache memory and temporarily store data stored in a lower-speed storage device than the RAM. As the lower-speed storage device than the RAM, a hard disk drive (HDD), an optical disc drive, a tape drive with a magnetic tape, or the like may be used. In addition, the information processing device 101 may be an HDD, and the cache memory may be included in the HDD. In this case, a cache controller is included in the HDD and controls the cache memory included in the HDD. The embodiment assumes that the RAM is treated as the cache memory and temporarily stores data stored in the HDD.

The data stored in the HDD may be arbitrary. For example, the data stored in the HDD may be stream data that is chronological data. The embodiment assumes that the HDD stores the stream data. The stream data includes one or more event data items. Each of the event data items is data indicating that an event has occurred. For example, the stream data is packets that are event data items and flowed in the Internet Protocol and were captured. For example, a certain event data item indicates that a Transmission Control Protocol (TCP) packet has flowed at a certain time.

A process executed for the accumulation of the stream data is a writing emphasized workload for which the performance of writing in the HDD is requested. In order to avoid failing to capture the stream data, most of an operating time of the HDD is assigned to writing access, and reading access is executed during the time when the writing access is not executed. Thus, the reading performance may be low in general.

In addition, it is assumed that the RAM stores data on an event data item basis. For example, the RAM temporarily stores event data items associated with and stored in partial regions obtained by dividing a storage region of the HDD. In addition, a storage region of the RAM is divided into blocks associated with the divided partial regions of the HDD. As a method of associating the partial regions with the blocks, the blocks may store addresses of the partial regions, or each of the blocks may store several lower bits of a respective partial region. Hereinafter, the blocks are referred to as “entries”.

Since the RAM that is treated as the cache memory has higher access performance than the HDD, the storage capacity of the RAM is smaller than that of the HDD. Thus, if a cache miss has occurred, an entry to be deleted is determined based on a predetermined cache replacement method, and an event data item read from the HDD is overwritten on the determined entry due to the cache miss. The cache replacement method is an algorithm for identifying an entry to be deleted from multiple entries. Examples of the cache memory replacement method are a Least Recently Used (LRU) method and a Least Frequently Used (LFU) method.

As an LRU method based on a time period for reading data from a storage region upon a cache miss, a Basic Cost-sensitive LRU (BCL) method exists. The BCL method is described below. First, in a device that executes the BCL method, costs are assigned to the entries of the cache memory. Each of the costs indicates an estimated time period for reloading an entry to the cache memory after the entry is deleted from the cache memory. In general, each of the costs is approximated based on a time period for previously reading data. Then, the device that executes the BCL method initializes a variable Acost when a certain entry moves to the top entry among LRU entries.

The top entry among the LRU entries is an entry that is not accessed for the longest time. Hereinafter, the top entry among the LRU entries is referred to as an “LRU entry”, while the most recently accessed entry is referred to as the “most recently used (MRU) entry”.

The initial value of the variable Acost is a cost assigned to the LRU entry. If a cache miss has occurred, the device that executes the BCL method uses the following method to determine an entry to be replaced. The device that executes the BCL method searches an LRU list in order from an entry positioned next to the LRU entry or from the entry that is not accessed for the second longest time, and the device that executes the BCL method checks costs of entries. If the device that executes the BCL method finds an entry to which a cost that is lower than the variable Acost is assigned, the device that executes the BCL method replaces the found entry and subtracts twice the cost of the found entry from the variable Acost. If the device that executes the BCL method does not finds the entry to which the cost that is lower than the variable Acost is assigned, the device that executes the BCL method replaces the LRU entry.

However, even if the BCL method is executed on a storage region accessed by a head of the HDD or the like, the reading performance may be reduced. For example, since the position of the head is changed over time, a time period for reading data from the storage region varies depending on the position of the head. Thus, if an entry to be deleted among the multiple entries of the cache memory is determined based on time periods for previously executing reading from storage regions, an entry from which data is read within a short time period is determined as the entry to be deleted, but a time period for reading executed next may be long. If the time period for reading executed next is long, the performance of reading using the cache memory from a storage region is reduced.

Most of a time period for reading stream data accumulated in the HDD is a seek time. The seek time is a time period for moving the head of the HDD to a specified position. The embodiment describes a method for calculating time periods for reading the LRU entry and the entry positioned next to the LRU entry from the HDD based on the current position of the head and deleting the entry positioned next to the LRU entry if the time period for reading the entry positioned next to the LRU entry is shorter.

An example of operations of the information processing device 101 is described with reference to FIG. 1. The information processing device 101 includes an HDD 102 and a RAM 103. The HDD 102 stores stream data. A method of expressing addresses of the HDD 102 may be Logical Block Addressing (LBA) or Cylinder Head Sector (CHS). The example illustrated in FIG. 1 assumes that the HDD 102 has divided partial regions identified by addresses 0 to 7 in order to simplify the description. The example illustrated in FIG. 1 assumes that each event data item is stored in a respective partial region of the HDD 102.

The RAM 103 temporarily stores event data items stored in the HDD 102. In the example illustrated in FIG. 1, the RAM 103 has four entries 104-1 to 104-4. In the RAM 103 illustrated in FIG. 1, the entries are sorted in the order from the entry 104-4 or the MRU entry to the entry 104-1 or the LRU entry. In the example illustrated in FIG. 1, the entry 104-1 stores an event data item stored in the partial region identified by the address 7 and included in the HDD 102. In addition, the entry 104-2 stores an event data item stored in the partial region identified by the address 5 and included in the HDD 102. The entry 104-3 stores an event data item stored in the partial region identified by the address 2 and included in the HDD 102. The entry 104-4 stores an event data item stored in the partial region identified by the address 0 and included in the HDD 102. It is assumed that the head is located at a position at which the head accesses the address 4 as a current writing position and that a request to read the partial region identified by the address 3 is provided.

In this case, since a cache miss occurs, the information processing device 101 deletes any of the entries 104-1 to 104-4 of the RAM 103. First, the information processing device 101 calculates, based on the position of a first partial region of the HDD 102 and the current position of the head, a first time period for reading the first partial region associated with a first entry, as indicated by (1) in FIG. 1. The first entry is determined as a candidate to be deleted based on a predetermined cache replacement method. In the example illustrated in FIG. 1, the first entry is the entry 104-1, and the first partial region is the partial region identified by the address 7. The information processing device 101 may use any of cache replacement methods such as the LRU method and the LFU method as the predetermined cache replacement method. For example, any of the cache replacement methods is specified by an administrator of the information processing device 101. The embodiment assumes that the LRU method is used.

For example, the information processing device 101 calculates the first time period as an absolute value of the difference between the position of the first partial region and the current position of the head. For example, the information processing device 101 may calculate the first time period by subtracting a smaller value of the position of the first partial region and the current position of the head from a larger value of the position of the first partial region and the current position of the head. Alternatively, the information processing device 101 may calculate the first time period by calculating the difference between the position of the first partial region and the current position of the head and multiplying the difference by −1 if the difference is smaller than 0.

In addition, as indicated by (2) in FIG. 1, the information processing device 101 calculates a second time period for reading a second partial region associated with a second entry based on the position of the second partial region of the HDD 102 and the current position of the head. The second entry is not determined as a candidate to be deleted based on the predetermined cache replacement method. Specifically, the second entry may be any entry other than the LRU entry. It is, however, preferable that the second entry be the entry positioned next to the LRU entry. In the example illustrated in FIG. 1, the second entry is the entry 104-2. In the same manner as the method described in (1) of FIG. 1, the information processing device 101 calculates the second time period.

In this case, the information processing device 101 may calculate the second time period after the calculation of the first time period in the aforementioned order or may calculate the first time period after the calculation of the second time period. In addition, the information processing device 101 may use the position of the head located upon the calculation of the first time period as the position of the head located upon the calculation of the second time period or may newly acquire the current position of the head in order to calculate of the second time period.

In the following description, a time period for reading a partial region associated with an entry is referred to as a “reading cost”. As the value of the reading cost is smaller, the time period for reading the partial region is shorter. In the example illustrated in FIG. 1, the reading cost of the entry 104-1 that is the first time period is 7−4=3, while the reading cost of the entry 104-2 that is the second time period is 5−4=1.

Then, as indicated by (3) in FIG. 1, if the reading cost of the second entry is smaller than the reading cost of the first entry, the information processing device 101 deletes the second entry. In the example illustrated in FIG. 1, since the reading cost of the entry 104-2 is smaller than the reading cost of the entry 104-1, the information processing device 101 deletes the entry 104-2. The RAM 103 illustrated on the right side of FIG. 1 is in a state after the deletion of the entry 104-2 or has entries 105-1 to 105-4. The entry 105-1 stores the event data item stored in the partial region identified by the address 7 within the HDD 102 or does not change from the state before the deletion of the entry 104-2. In addition, the entry 105-2 stores the event data item stored in the partial region identified by the address 2 within the HDD 102. The entry 105-3 stores the event data item stored in the partial region identified by the address 0 within the HDD 102. The entry 105-4 stores an event data item stored in the partial region identified by the address 3 within the HDD 102.

If the reading cost of the first entry is smaller than the reading cost of the second entry, the information processing device 101 may delete the first entry or search an entry whose reading cost is smaller than the reading cost of the first entry. In the example illustrated in FIG. 1, the information processing device 101 may calculate the reading cost of the entry 104-3 and compare the calculated reading cost with the reading cost of the entry 104-1, for example.

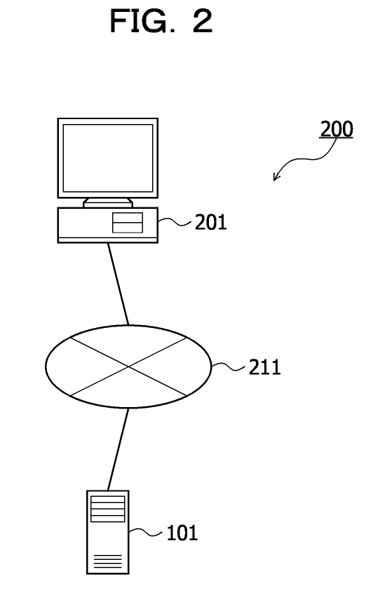

Since the information processing device 101 leaves the entry 104-1 located far from the current position of the head, the average reading performance is improved. In the example illustrated in FIG. 1, the storage regions are included in the HDD. The storage regions, however, may be storage regions accessible from any storage device as long as a relative position of a head to a storage region is changed over time. For example, an optical disc drive that includes a movable head may be applied instead of the HDD, and an optical disc that is accessed by the optical disc drive may be used as the storage regions. Alternatively, a storage device, which has a head whose position is fixed and whose relative position to a storage region is changed over time due to the movement of the storage region, may be applied. For example, a tape drive may be applied instead of the HDD, and a magnetic tape may be used as the storage regions. Next, a storage system that includes the information processing device 101 is described with reference to FIG. 2.

FIG. 2 illustrates a detailed example of the storage system 200. The storage system 200 includes a client device 201 and the information processing device 101. The client device 201 and the information processing device 101 are coupled to each other via a network 211.

The client device 201 is a computer that transmits a write request and a read request to the information processing device 101 based on operations by a user of the storage system 200 or the like. Operations to be executed for the transmission of the write request and read request are described below.

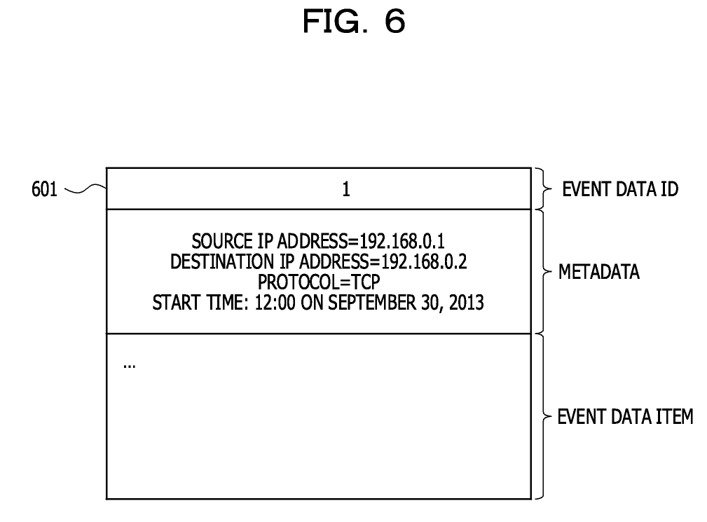

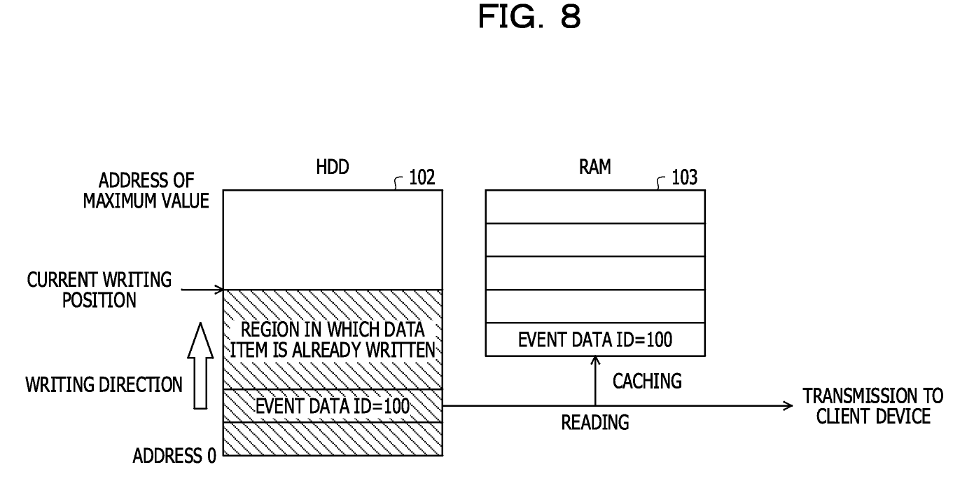

Regarding the write request, the client device 201 forms an event data item from received stream data and transmits, to the information processing device 101, the write request including the event data item having an event data identifier (ID) uniquely identifying the event data item. A specific example of the write request is described later with reference to FIG. 6. The information processing device 101 receives the write request and writes the event data item in the HDD 102. In order to improve the writing performance, the information processing device 101 sequentially writes event data items in the HDD 102. The writing is described later with reference to FIG. 8.

Regarding the read request, the client device 201 transmits, to the information processing device 101, the read request including an event data ID. The read request includes only the event data ID of an event data item to be read and thus is not illustrated. The information processing device 101 receives the read request, reads the specified event data item from the HDD 102, and transmits the read event data item to the client device 201. Access to the HDD 102 for the reading is random access in general. In order to increase the speed of the reading executed upon re-access to the read event data item, the information processing device 101 stores the read event data item in the RAM 103. The reading is described later with reference to FIG. 8.

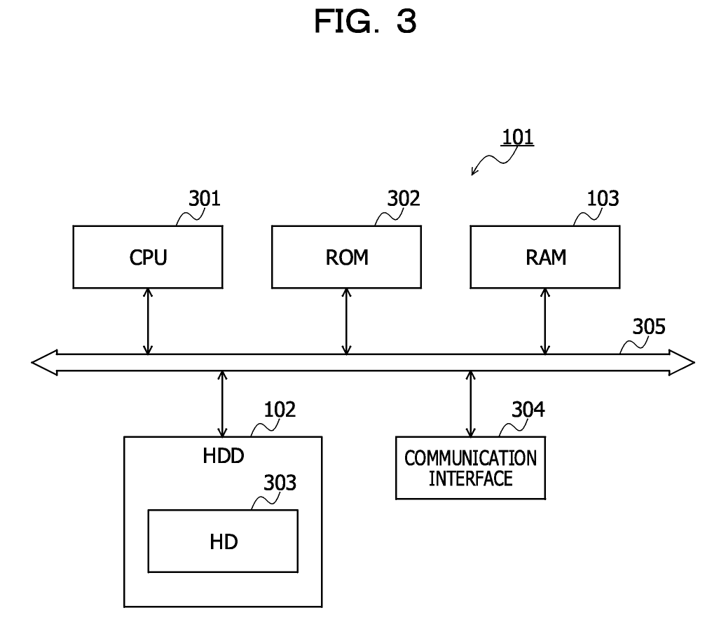

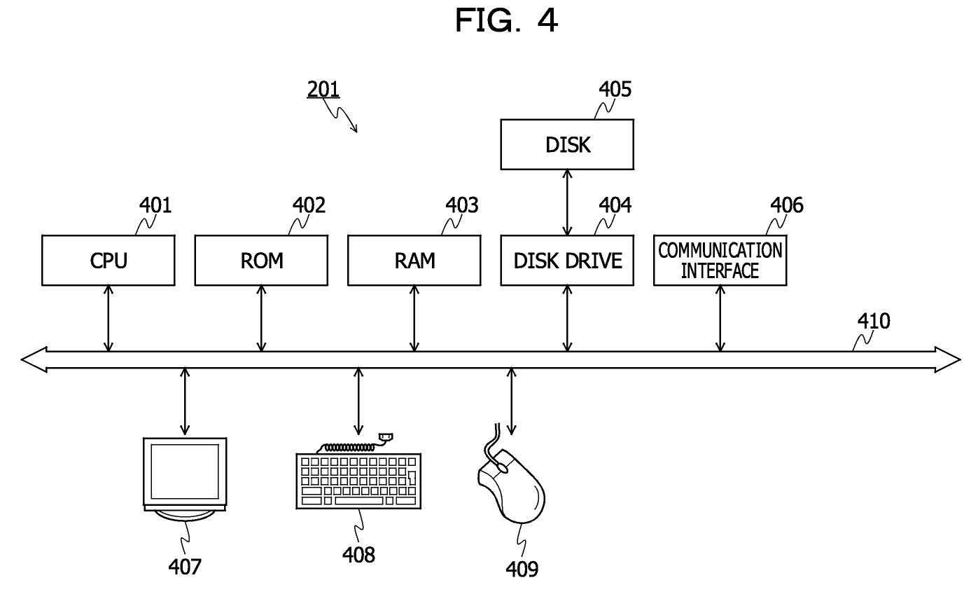

The information processing device 101 is the server that receives the write request and the read request from the client device 201 and processes the write request and the read request. Next, hardware configurations of the information processing device 101 and client device 201 are described with reference to FIGS. 3 and 4.

FIG. 3 is a block diagram illustrating an example of the hardware configuration of the information processing device 101. Referring to FIG. 3, the information processing device 101 includes a central processing unit (CPU) 301, a read only memory (ROM) 302, and the RAM 103, the HDD 102, a hard disk (HD) 303, and a communication interface 304. The CPU 301, the ROM 302, the RAM 103, the HDD 102, and the communication interface 304 are coupled to each other via a bus 305.

The CPU 301 is an arithmetic processing device that controls the overall the information processing device 101. The ROM 302 is a nonvolatile memory that stores programs including a boot program. The RAM 103 is a volatile memory that is used as a work area of the CPU 301.

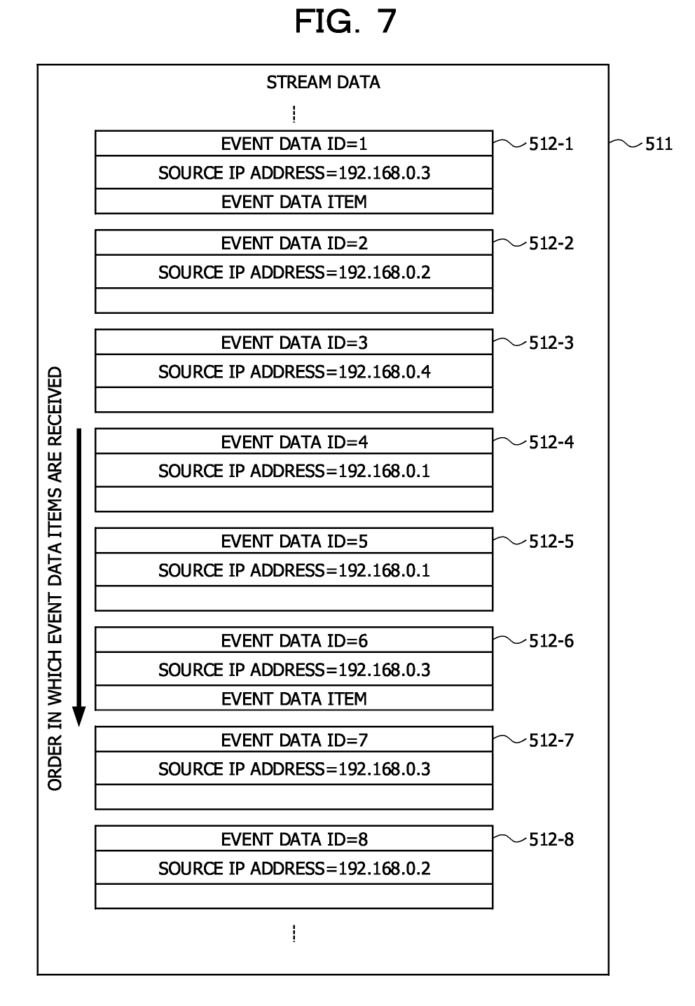

The HDD 102 includes the HD 303. The HDD 102 is a control device that controls reading and writing of data from and in the HD 303 in accordance with control by the CPU 301. The HD 303 is a storage medium that stores data written in accordance with control by the HDD 102. The HD 303 stores stream data. An example of the stream data is described later with reference to FIG. 7.

The communication interface 304 is a control device that serves as an interface between the network and the inside of the information processing device 101 and controls the input and output of data from and to another device. For example, the communication interface 304 is coupled to the other device via a communication line and the network. As the communication interface 304, a modem, a LAN adaptor, or the like may be used.

If an administrator of the storage system 200 directly operates the information processing device 101, the information processing device 101 may include hardware such as a display, a keyboard, and a mouse.

FIG. 4 is a block diagram illustrating an example of the hardware configuration of the client device 201. The client device 201 includes a CPU 401, a ROM 402, and a RAM 403. In addition, the client device 201 includes a disk drive 404, a disk 405, and a communication interface 406. Furthermore, the client device 201 includes a display 407, a keyboard 408, and a mouse 409. The CPU 401, the ROM 402, the RAM 403, the disk drive 404, the communication interface 406, the display 407, the keyboard 408, and the mouse 409 are coupled to each other via a bus 410.

The CPU 401 is an arithmetic processing device that controls the overall client device 201. The ROM 402 is a nonvolatile memory that stores programs including a boot program. The RAM 403 is a volatile memory that is used as a work area of the CPU 401.

The disk drive 404 is a control device that controls reading and writing of data from and in the disk 405 in accordance with control by the CPU 401. As the disk drive 404, a magnetic disk drive, an optical disc drive, a solid state drive, or the like may be used, for example. The disk 405 is a nonvolatile memory that stores data written in accordance with control by the disk drive 404. For example, if the disk drive 404 is a magnetic disk drive, a magnetic disk may be used as the disk 405. If the disk drive 404 is an optical disc drive, an optical disc may be used as the disk 405. If the disk drive 404 is a solid state drive, a semiconductor memory composed of semiconductor elements or a so-called semiconductor disk may be used as the disk 405.

The communication interface 406 is a control device that serves as an interface between the network and the inside of the client device 201 and controls the input and output of data from and to an external device. For example, the communication interface 406 is coupled to the other device via a communication line and the network. As the communication interface 406, a modem, a LAN adaptor, or the like may be used.

The display 407 is a device that displays a mouse cursor, icons, tool boxes, and data such as documents, images, and function information. As the display 407, a cathode ray tube (CRT), a thin film transistor (TFT) liquid crystal display, a plasma display, or the like may be used.

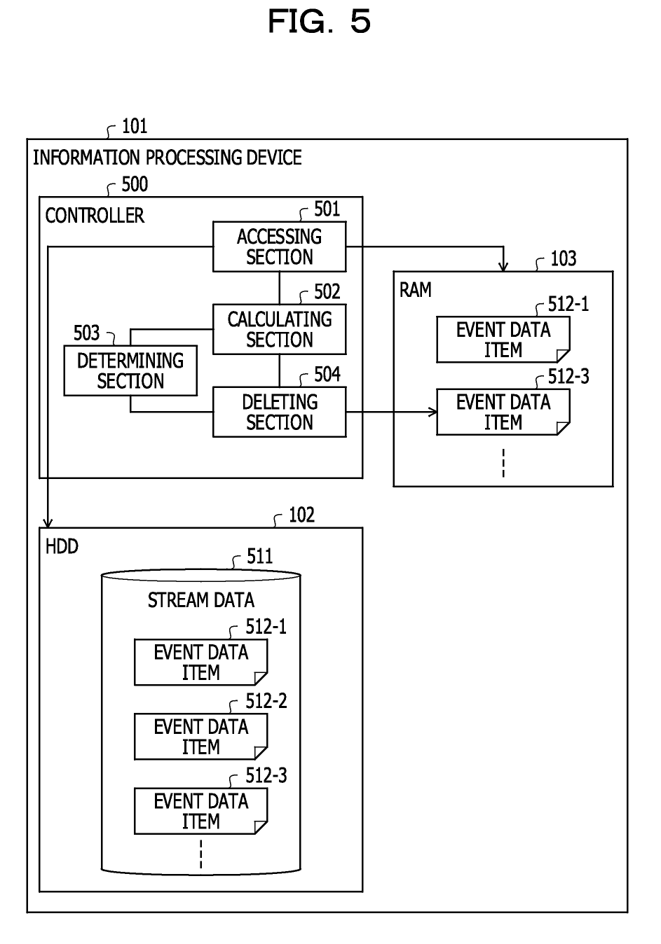

The keyboard 408 is a device that has keys to be used to input characters, numbers, various instructions, and the like and inputs data. Alternatively, the keyboard 408 may be a touch-panel type input pad, a numeric keypad, or the like. The mouse 409 is a device that moves the mouse cursor, selects a range, moves a window, changes a size, and the like. The mouse 409 may be replaced with a trackball, a joystick, or the like as long as the trackball, the joystick, or the like functions as a pointing device in the same manner as the mouse 409. Next, an example of a functional configuration of the information processing device 101 is described with reference to FIG. 5.

Example of Functional Configuration of Information Processing Device 101

FIG. 5 is a block diagram illustrating the example of the functional configuration of the information processing device 101. The information processing device 101 includes a controller 500. The controller 500 includes an accessing section 501, a calculating section 502, a determining section 503, and a deleting section 504. The controller 500 achieves functions of the sections when the CPU 301 executes a program stored in a memory device. The memory device is the ROM 302 illustrated in FIG. 3, the RAM 103 illustrated in FIG. 3, the HDD 102 illustrated in FIG. 3, or the like. The results of processes by the sections are stored in a register of the CPU 301, the RAM 103, or the like.

The CPU 301 is able to access the HDD 102 and the RAM 103. The HDD 102 stores stream data 511. The stream data 511 includes event data items 512-1 to 512-3 and the like. The RAM 103 stores a portion of the event data items 512 of the stream data 511. In the example illustrated in FIG. 5, the RAM 103 stores the event data items 512-1 and 512-3 and the like.

The accessing section 501 accesses the HDD 102 in accordance with a write request and a read request and accesses the RAM 103 in accordance with a write request and a read request.

The calculating section 502 calculates, based on the current position of the head and the position of a partial region included in the HDD 102 and associated with the first entry among the entries, the reading cost of the first entry that is determined based on the LRU method as a candidate to be deleted. In addition, the calculating section 502 calculates, based on the current position of the head and the position of a partial region included in the HDD 102 and associated with the second entry among the entries, the reading cost of the second entry that is not determined based on the LRU method as a candidate to be deleted. Furthermore, the calculating section 502 calculates the reading cost of the first entry and the reading cost of the second entry in response to the occurrence of a cache miss by the accessing section 501.

The determining section 503 determines whether or not the reading cost, calculated by the calculator 502, of the second entry is smaller than the reading cost, calculated by the calculator 502, of the first entry. It is assumed that the information processing device 101 deletes a third entry different from the LRU entry in response to the occurrence of a cache miss before a certain cache miss. In this case, the determining section 503 may determine whether or not the second entry is to be deleted, based on the reading cost of the third entry, the reading cost of the first entry, and the reading cost of the second entry.

For example, if a value obtained by subtracting the reading cost of the third entry from the reading cost of the first entry is larger than the reading cost of the second entry, the determining section 503 determines that the second entry is to be deleted. In addition, if the reading cost of the first entry is larger than a value obtained by adding the reading cost of the third entry to the reading cost of the second entry, the determining section 503 may determine that the second entry is to be deleted.

If the reading cost of the second entry is smaller than the reading cost of the first entry, the deleting section 504 deletes the second entry. Alternatively, if the determining section 503 determines that the second entry is to be deleted, the deleting section 504 deletes the second entry. In the example illustrated in FIG. 5, the deleting section 504 deletes the event data item 512-3 within the RAM 103. Next, an example of the write request received from the client device 201 is described with reference to FIG. 6.

FIG. 6 illustrates the example of the write request. As illustrated in FIG. 6, the write request is composed of three data items, an event data ID, metadata, and an event data item. The event data ID is provided by the client device 201 and is a value identifying the event data item. The metadata is an attribute attached to the event data item. The event data item is data indicating that an event has occurred.

In the example illustrated in FIG. 6, a write request 601 indicates that an event data ID is 1, a source IP address is “192.168.0.1”, a destination IP address is “192.168.0.2”, and a protocol is the “TCP”. In addition, the write request 601 indicates that the transmission of the event data item is started at “12:00 on Sep. 30, 2013”.

FIG. 7 illustrates an example of the stream data 511. Specifically, FIG. 7 illustrates the example of the stream data 511 written in the HDD 102 in accordance with a write request. An event data item that is a portion of the stream data 511 and is the first event data item that reached the information processing device 101 after a certain time point is the event data item 512-1 with an event data ID 1. A source IP address of the event data item 512-1 is “192.168.0.3”. Event data items that are portions of the stream data 511 and are the second to eighth event data items that reached the information processing device 101 after the certain time point are the event data items 512-2 to 512-8 with event data IDs 2 to 8.

FIG. 8 illustrates access to the HDD 102 of the server upon writing and reading. When receiving a write request, the information processing device 101 writes an event data item in order from the address 0 to an address of the maximum value. In the example illustrated in FIG. 8, a hatched region indicates a region in which an event data item is already written. When an event data item is written in a partial region identified by the address of the maximum value, the information processing device 101 overwrites an old event data item in the partial region identified by the address 0.

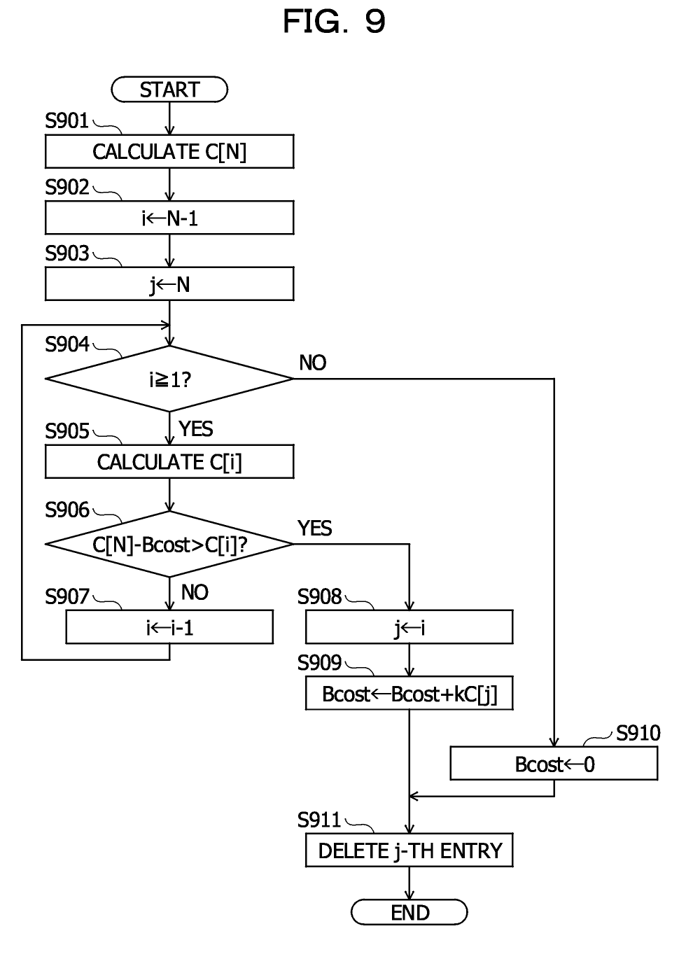

When receiving a read request, the information processing device 101 reads, from the HDD 102, an event data item specified in the read request and transmits the read event data item to the client device 201. In addition, the information processing device 101 stores the read event data item in the RAM 103. In the example illustrated in FIG. 8, the information processing device 101 reads an event data item identified by an event data ID 100 from the HDD 102, transmits the read event data item to the client device 201, and stores the event data item identified by the event data ID 100 in the RAM 103. Next, a flowchart of an entry replacement process is described with reference to FIG. 9.

FIG. 9 is a flowchart of an example of the entry replacement process. The entry replacement process is a process of deleting an entry selected from among multiple cache entries and writing a new entry. In addition, Bcost, N, and C[i] that are used in FIG. 9 are described below.

Bcost is a variable to be used to avoid causing the LRU entry to continuously remain. The information processing device 101 initializes Bcost when any cache entry moves to the LRU entry. The initial value of Bcost is 0. Bcost increases when an entry other than the LRU entry is deleted.

N indicates the number of entries able to be held in the RAM 103. It is assumed that the entries are sorted in the order from the MRU entry to the LRU entry. For example, the first entry is the MRU entry, and the N-th entry is the LRU entry.

C[i] indicates the current reading cost of an event data item corresponding to the i-th entry. For example, the information processing device 101 calculates the current reading cost in accordance with the following Equation (1).

C[i]=|(an address at which writing is currently executed)−(an address on the HDD 102 that is associated with the entry of C[i]| (1)

In Equation (1), |x| indicates an absolute value of x. In addition, it is assumed that the information processing device 101 recognizes addresses on the HDD 102 at which all event data items are stored and identifies addresses on the HDD 102 at which event data items corresponding to the entries are stored.

If a cache miss has occurred, the information processing device 101 calculates C[N] (in step S901). Then, the information processing device 101 substitutes N−1 into i (in step S902). In addition, the information processing device 101 substitutes N into j (in step S903). Then, the information processing device 101 determines whether or not i is equal to or larger than 1 (in step S904). If i is equal to or larger than 1 (Yes in step S904), the information processing device 101 calculates C[i] (in step S905).

Then, the information processing device 101 determines whether or not C[N]−Bcost is larger than C[i] (in step S906). The value obtained by subtracting Bcost from C[N] indicates that as a time period for which the LRU entry continuously remains is longer, the LRU entry is deleted more easily. If C[N]−Bcost is equal to or smaller than C[i] (No in step S906), the information processing device 101 substitutes i−1 into i (in step S907). Then, the information processing device 101 causes the entry replacement process to proceed to step S904.

If C[N]−Bcost is larger than C[i] (Yes in step S906), the information processing device 101 substitutes i into j (in step S908). Then, the information processing device 101 substitutes Bcost+kC[j] into Bcost (in step S909). In this case, k is a positive real number. The value of k is determined based on tuning of the administrator of the information processing device 101 or the like.

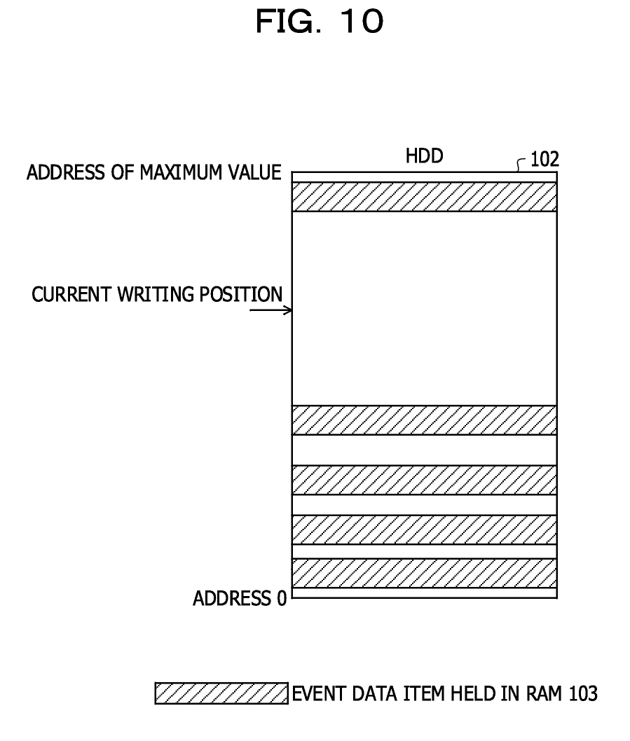

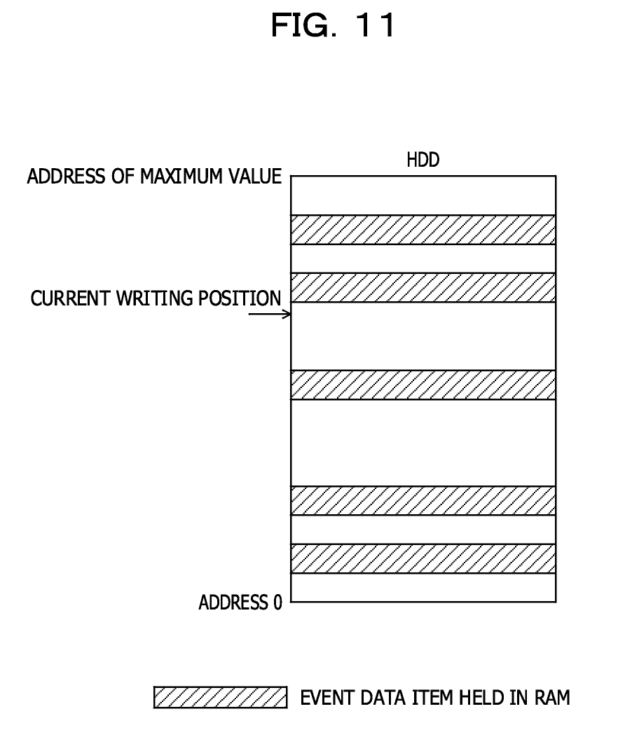

If i is smaller than 1 (No in step S904), the information processing device 101 substitutes 0 into Bcost (in step S910). After the termination of the process of step S909 or the termination of the process of S910, the information processing device 101 deletes the j-th entry (in step S911). After the termination of the process of step S911, the information processing device 101 terminates the entry replacement process. Next, a method for controlling the cache memory according to the embodiment is described and compared with the LRU method with reference to FIGS. 10 and 11.

FIG. 10 illustrates an example of the usage statuses of the RAM 103 and HDD 102 when the method for controlling the cache memory according to the embodiment is executed. Hatched regions illustrated in FIG. 10 indicate regions in which event data items held as entries of the RAM are stored. As illustrated in FIG. 10, an event data item located far from the current writing position easily remains in the RAM 103. The reading performance per unit of time is improved by a reduction in the average of time periods for reading the event data items.

FIG. 11 illustrates an example of usage states of the RAM 103 and HDD 102 when the LRU method is executed. Hatched regions illustrated in FIG. 11 are regions in which event data items held as entries of the RAM are stored. As illustrated in FIG. 11, it is apparent that event data items remain in the RAM regardless of the current writing position. When a request to read an event data item that is read for a long time is provided, a probability that the event data item is read from the HDD 102 is higher, compared with the state illustrated in FIG. 10. In a such case, the average of time periods for reading event data items is longer, compared with the state illustrated in FIG. 10.

As described above, the information processing device 101 calculates, from the current position of the head, the cost of reading the first entry or the LRU entry from the HDD and the cost of the second entry or the entry positioned next to the LRU entry from the HDD. If the reading cost of the second entry is smaller than the reading cost of the first entry, the information processing device 101 deletes the second entry. Thus, entries that are far from the current position of the head remain, and the average reading performance is improved.

It is assumed that the third entry that is different from the LRU entry is deleted in response to the occurrence of a cache miss before a certain cache miss. In this case, the information processing device 101 may determine whether or not the second entry is to be deleted, based on the reading cost of the third entry, the reading cost of the LRU entry, and the reading cost of the second entry. For example, the information processing device 101 makes the determination so that the LRU entry is easily deleted. The reason for easily deleting the LRU entry is that, even if the LRU entry is associated with a divided region located far from the current position of the head and is not accessed for a long time, it is better to leave another entry than the LRU entry. Thus, the RAM 103 is efficiently used and the reading performance is improved.

In addition, the information processing device 101 may not randomly write data in the HDD 102 and may write data in the HDD 102 only sequentially. In this case, the performance of sequential access to the HDD is higher than the performance of random access to the HDD 102, and the writing performance is improved. If the information processing device 101 writes data in the HDD 102 only sequentially, and data is randomly read from the HDD 102, a seek time for writing after the termination of the reading is short in a case where a position at which the data is read is located near the current writing position. Thus, the writing performance after the termination of the reading is improved.

In addition, the information processing device 101 may write stream data in the HDD 102. Any storage device that has a storage region that is accessed by the head is applicable to the embodiment. An optical disc drive and a tape drive with a magnetic tape are applicable to the embodiment.

The method, described in the embodiment, of controlling the cache memory is achieved by causing a computer such as a personal computer or a workstation to execute a program prepared in advance. The program for controlling the cache memory is stored in a computer-readable storage medium such as a hard disk, a flexible disk, a compact disk-read only memory (CD-ROM), or a digital versatile disc (DVD). The program for controlling the cache memory is read by the computer from the storage medium and executed by the computer. The program for controlling the cache memory may be distributed via a network such as the Internet.

The information processing device 101 described in the embodiment may be achieved by an application specific integrated circuit (hereinafter merely referred to as “ASIC”) such as a standard-cell ASIC or a structured ASIC or a programmable logic device (PLD) such as a field programmable gate array (FPGA). For example, if the information processing device 101 is an HDD, the HDD according to the embodiment is manufactured by functionally defining the accessing section 501, the calculating section 502, the determining section 503, and the deleting section 504 by HDL descriptions, logically synthesizing the HDL descriptions, and providing the descriptions to the ASIC or the PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A device comprising:
a memory; and
a processor coupled to the memory and configured to:
calculate, based on a position of a first partial region within a storage region of a storage device and a current position of a head included in the storage device, a first time period for reading the first partial region associated with a first block that is among blocks, which are associated with partial regions obtained by dividing the storage region of the storage device and to be accessed by the head and temporarily store data stored in the partial regions, and that is determined as a candidate to be deleted based on a predetermined cache replacement method,
calculate, based on a position of a second partial region within the storage region and the current position of the head, a second time period for reading the second partial region associated with a second block that is among the blocks and is not determined as the candidate to be deleted based on the predetermined cache replacement method, and
delete the second block when the processor determines that the second time period is shorter than the first time period.

2. The device according to claim 1, wherein the processor is further configured to:
calculate, in response to an occurrence of a first cache miss to at least one of the blocks, the first time period based on the position of the first partial region within the storage region and the current position of the head, and calculate the second time period based on the position of the second partial region within the storage region and the current position of the head,
determine, when a third block that is different from the first block has been deleted in response to an occurrence of a second cache miss before the first cache miss, whether or not the second block is to be deleted, based on the first time period, the second time period, and a third time period for reading a third partial region associated with the third block, and
delete the second block when the processor determines that the second block is to be deleted.

3. The device according to claim 1, wherein the processor is further configured to execute control to sequentially write data in the storage region.

4. The device according to claim 1, wherein
the storage device is a magnetic disk drive, and
the storage region is a magnetic disk that is controlled by the magnetic disk drive.

5. The device according to claim 1, further comprising:
a cache memory including the blocks.

6. A method of controlling a cache memory, the method comprising:
first calculating, by a processor, based on a position of a first partial region within a storage region of a storage device and a current position of a head included in the storage device, a first time period for reading the first partial region associated with a first block that is among blocks in the cache memory, which are associated with partial regions obtained by dividing the storage region of the storage device and to be accessed by the head and temporarily store data stored in the partial regions, and that is determined as a candidate to be deleted based on a predetermined cache replacement method;
second calculating, by the processor, based on a position of a second partial region within the storage region and the current position of the head, a second time period for reading the second partial region associated with a second block that is among the blocks and is not determined as the candidate to be deleted based on the predetermined cache replacement method; and
deleting, by the processor, the second block when it is determined that the second time period is shorter than the first time period.

7. The method according to claim 6, wherein
the first calculating calculates, in response to an occurrence of a first cache miss to at least one of the blocks, the first time period based on the position of the first partial region within the storage region and the current position of the head, and the second calculating calculates the second time period based on the position of the second partial region within the storage region and the current position of the head,
the method further comprises:
determining, when a third block that is different from the first block has been deleted in response to an occurrence of a second cache miss before the first cache miss, whether or not the second block is to be deleted, based on the first time period, the second time period, and a third time period for reading a third partial region associated with the third block, and
the deleting deletes the second block when the determining determines that the second block is to be deleted.

8. The method according to claim 6, further comprising:
controlling to sequentially write data in the storage region.

9. The method according to claim 6, wherein
the storage device is a magnetic disk drive, and
the storage region is a magnetic disk that is controlled by the magnetic disk drive.

10. A non-transitory storage medium storing a program for causing a computer to execute a process, the process comprising:
first calculating, based on a position of a first partial region within a storage region of a storage device and a current position of a head included in the storage device, a first time period for reading the first partial region associated with a first block that is among blocks in the cache memory, which are associated with partial regions obtained by dividing the storage region of the storage device and to be accessed by the head and temporarily store data stored in the partial regions, and that is determined as a candidate to be deleted based on a predetermined cache replacement method;
second calculating, based on a position of a second partial region within the storage region and the current position of the head, a second time period for reading the second partial region associated with a second block that is among the blocks and is not determined as the candidate to be deleted based on the predetermined cache replacement method; and
deleting the second block when it is determined that the second time period is shorter than the first time period.

11. The storage medium according to claim 10, wherein
the first calculating calculates, in response to an occurrence of a first cache miss to at least one of the blocks, the first time period based on the position of the first partial region within the storage region and the current position of the head, and the second calculating calculates the second time period based on the position of the second partial region within the storage region and the current position of the head,
the process further comprises:
determining, when a third block that is different from the first block has been deleted in response to an occurrence of a second cache miss before the first cache miss, whether or not the second block is to be deleted, based on the first time period, the second time period, and a third time period for reading a third partial region associated with the third block, and
the deleting deletes the second block when the determining determines that the second block is to be deleted.

12. The storage medium according to claim 10, wherein the process further comprises:
controlling to sequentially write data in the storage region.

13. The storage medium according to claim 10, wherein
the storage device is a magnetic disk drive, and
the storage region is a magnetic disk that is controlled by the magnetic disk drive.

14. The storage medium according to claim 10, wherein
the computer includes a cache memory including the blocks.
